(19) United States
(12) Patent Application Publication
(10) Pub. No.: US 2004/0057142 A1
(43) Pub. Date: Mar. 25, 2004

(54) Method of making stress-resistant anti-reflection multilayer coatings containing cerium oxide

(75) Inventor: Nanning J. Arfsten, Moorestown, NJ (US)

Correspondence Address: AKIN GUMP STRAUSS HAUER & FELD L.L.P., ONE COMMERCE SQUARE, 2005 MARKET STREET, SUITE 2200, PHILADELPHIA, PA, 19103-7013, US

(73) Assignee: DENGLAS TECHNOLOGIES, L.L.C.

(21) Appl. No.: 10/616,663

(22) Filed: Jul. 10, 2003

Related U.S. Application Data
(60) Provisional application No. 60/394,766, filed on Jul. 10, 2002.

(51) Int. Cl. G02B 5/08; G02B 7/182

(52) U.S. Cl. 359/883

(57) ABSTRACT

Methods for producing stress-resistant, antireflective, thin film, sol-derived, optical coatings are provided. The methods comprise providing to a substrate a thin film optical coating including a layer of sol-gel derived cerium oxide and an oxide of silicon, nickel and/or a transition metal selected from Group IIIB through Group VIB of the Periodic Table which is capable of providing a refractive index of at least about 1.90. A multilayer stress-resistant coating is prepared by coating a substrate with an inner layer containing an oxide of titanium and an oxide of silicon, coating the inner layer with a middle layer containing cerium oxide and at least one metal oxide, and coating the middle layer with an outer layer containing an oxide of silicon. Further, a method is provided for producing a thin film optical coating including a layer of sol-gel derived cerium oxide, silicon dioxide, and at least one oxide of a transition metal selected from Group IIIB through Group VIB of the Periodic Table by immersing a substrate in a solution comprising cerium nitrate hexahydrate, an alcohol and a metal compound, withdrawing the substrate from the solution, and heat treating the coated substrate to form the metal oxides. The coatings may be subjected to heat treatments such as tempering or bending and are resistant to cracking and crazing, and thus may be applicable for making articles containing bent glass, such as display cases.

### CROSS-REFERENCE TO RELATED APPLICATION

This application claims the benefit of U.S. Provisional Patent Application No. 60/394,766, filed Jul. 10, 2002.

### BACKGROUND OF THE INVENTION

Thin film optical coatings can be used to alter a substrate's optical properties. For example, the reflection of light which occurs at the interface between two different materials may be altered by applying a thin film optical coating to a surface at such an interface. Additionally, the transmission of light can be reduced by an absorbent optical coating or the transmittance/absorbance of specific wavelengths can be enhanced.

It is often desirable to reduce the percentage of visible light which is reflected at an interface and increase the transmittance of visible light, thus reducing glare associated with the reflection of visible light. Anti-reflection thin film optical coatings for such purposes have numerous applications including, for example, display cases, windows, lenses, picture frames and visual display devices such as computer monitors, television screens, calculators and clock faces.

Generally, the reflection of light occurs at the interface between two materials which have different indices of refraction, for example, glass and air. Air has an index of refraction, n, of approximately 1.00 and glass generally has an index of refraction of approximately 1.51, so that when light which was previously travelling through air becomes incident upon a glass surface, some of the light is refracted (bent) and travels through the glass at an angle different from the angle of incidence, and some of the light is reflected. Theoretically, in order to minimize the amount of light which is reflected from a glass surface, it would be ideal to coat the glass with a material having an index of refraction which is the square root of 1.51, which is the index of refraction of glass. However, there are very few durable materials which have such a specific index of refraction (i.e., 1.2288).

In order to overcome the problem created by the lack of durable materials having the requisite index of refraction, thin film coatings having multilayer designs have been developed. Prior multilayer anti-reflection coatings have included two, three, four and more layers. By using multilayer coatings with layers that have high, medium and low indices of refraction, in various combinations and orders, prior coating systems have been able to reduce the reflection of visible light at air/substrate interfaces to negligible percentages. However, each layer in a multi-layer coating system increases the overall cost of the coating system.

There are many different examples of multilayer coating systems that have previously been used. Two, three and four layer anti-reflection coatings are known and are described, for example, in H. A. Macleod, “Thin Film Optical Filters,” Adam Hilger, Ltd., Bristol 1985. The coatings are designed to provide specific indices of refraction for different applications to deliver required optical properties. Indices of refraction are material constants. The index of refraction of a material, the amounts of a material, the combinations of materials and layer thicknesses all affect the optical properties of the resulting system. One such system commonly used is a “three-layer low” multilayer coating which has a medium index of refraction layer (“M-layer”) coated on the substrate, the M-layer having an index of refraction (“n”) of from 1.60 to 1.90, a high index of refraction layer (“H-layer”) coated on the M-layer, the H-layer having an n greater than 1.90, and a low index of refraction layer (“L-layer”) coated on the H-layer, the L-layer having an n less than 1.60, (thus providing an overall M/H/L structure). Other designs include bilayer coatings which generally have an M/L design which includes an inner M-layer and an outer L-layer. Such designs are useful, for example, with laser optic applications. Four layer systems are also known which generally have an H/L/H/L design and include an inner H-layer coated with an L-layer followed by a further H layer and L layer. Such coatings are typically used for technical applications which need to accommodate a somewhat greater amount of light passing through the coating than for standard applications.

Materials which are currently used in thin film optical coatings as layers having a high index of refraction include titanium oxide, hafnium oxide and other transition metal oxides. However, in order to produce durable coating layers of these high index of refraction materials, it is often necessary to use expensive techniques such as vacuum evaporation or sputtering. The cost of the equipment used in such application processes can often create an economically unfeasible approach to producing such coatings.

Other techniques by which layers of thin film optical coatings have been applied to substrates include the use of sol-gel technology. A common sol-gel technique includes the application of a solution to a substrate, with the subsequent conversion of an oxide precursor contained within the solution, to an oxide on the surface of the substrate. This method generally involves the removal of water by heat treatment. An alternative and more recently adapted technique of sol-gel chemistry involves the application of a colloidal suspension (sol) of a chemically converted oxide to a substrate with the subsequent evaporation of the suspending medium at room temperature. The first method is usually preferable due to the difficulties which may be encountered during the preparation of adequate colloidal suspensions.

The use of sol-gel chemistry in applying thin film optical coatings is desirable due to the prohibitive capital expenses associated with vacuum deposition equipment.

When a sol-gel method is used to coat a substrate, the coating that is deposited generally requires a final heat cure to convert the coating into the desired oxide. A common cure temperature used in sol-gel applications is approximately 400° C. There are many materials that have melting or decomposition points below 400° C., including, for example, certain plastics and other polymeric resins. Thus, thin film optical coatings cannot be coated on a large class of materials (i.e., those with melting points below 400° C.) using conventional sol-gel processes. Currently, heat-sensitive materials are coated by vacuum deposition.

In numerous applications, such as in the production of glass display cases, it is necessary to subject the coated glass to further heat treatments, such as tempering at high temperatures and/or bending. However, many difficulties are often encountered in applying antireflection or other optical coatings to glass which is to be tempered because thinning of the coating layers occurs, typically with respect to the outer layer of a multilayer antireflection coating. The outer layer may be burned off and/or the entire coating system distorted. Further, the index of refraction may be affected due to changes in the crystal structure or density changes of some materials during tempering. Such changes affect the optical properties of the whole system. Titanium dioxides, which are commonly used as a middle layer in three layer antireflection coatings, are significantly affected by tempering.

In addition to the above-noted problems, the quick cooling used in the tempering process, which induces the desired stress within the glass, unfortunately also induces undesirable stress into the antireflection or other optical coating subjected to tempering. The stress in the coating, however, is not beneficial and often leads to disintegration, cracks or microcracks. The coating will appear hazy as a result, or may be completely destroyed such that it cracks or flakes off.

Because of the disadvantageous results of tempering coated glass, antireflection coatings have been applied using various coating techniques after the glass has been tempered. Unfortunately, this means that large pieces of commercial glass must first be cut and shaped, then tempered. As a result, coating is done on smaller, pre-cut pieces of tempered glass. This process is time-consuming, inefficient, and, therefore, tends to be uneconomical.

During bending of coated glass to produce articles such as display cases, stresses are applied to the glass, which may result in damage to the coatings in the form of cracking and/or crazing. Traditional methods for reducing cracking involve the utilization of thick coatings. However, it is not possible to maintain desired antireflection properties when using a thick coating. Therefore, a need remains for a method of reducing cracking and crazing when subjecting antireflection coated substrates to heat treatments such as tempering and bending.

### BRIEF SUMMARY OF THE INVENTION

According to the present invention, a method for producing a stress-resistant, heat-treated, anti-reflection coated inorganic substrate that is resistant to cracking and crazing is provided. The method comprises coating an inorganic substrate with an inner layer comprising an oxide of titanium and an oxide of silicon; coating the inner layer with a middle layer comprising a mixture of an oxide of cerium and at least one oxide of a metal selected from the group consisting of silicon, nickel, and transition metals of Group IIIB, Group IVB, Group VB and Group VIB of the Periodic Table; coating the middle layer with an outer layer comprising an oxide of silicon; and heat treating the coated inorganic substrate. The reference to Group IIIB through Group VIB uses the notation shown in the Periodic Table in General Chemistry Principles and Modem Applications, 3 ed., Ralph H. Petrucci, 1982, ISBN 0-02-395010-2.

According to another embodiment of the present invention, a method for producing a stress-resistant, heat-treated, anti-reflection coated inorganic substrate that is resistant to cracking and crazing comprises providing to an inorganic substrate a coating having a refractive index of at least about 1.90 comprising a mixture of cerium oxide and at least one oxide of a metal selected from the group consisting of silicon, nickel and transition metals of Group IIIB, Group IVB, Group VB and Group VIB, and heat treating the coated inorganic substrate.

According to a further embodiment of the invention, a method for producing a stress-resistant heat-treated sol-gel derived thin film, anti-reflection optical coating that is resistant to cracking and crazing on an inorganic substrate is provided. The method comprises immersing an inorganic substrate in an M solution comprising tetraethylorthosilicate and the reaction product of TiCl₄ and ethanol; withdrawing the substrate from the M solution to provide the substrate with a coating of the M solution and heat treating the substrate to form a silicon dioxide and TiO₂ layer having a refractive index of about 1.60 to about 1.90. The method further comprises immersing the substrate in an H mixture comprising cerium nitrate hexahydrate, tetraethylorthosilicate and at least one transition metal compound from Group IIIB, Group IVB, Group VB or Group VIB of the Periodic Table; withdrawing the substrate from the H mixture to provide the substrate with a coating of the H mixture and heat treating the substrate to form an oxide layer having a refractive index of at least about 1.9. Finally, the method comprises immersing the substrate in an L solution comprising tetraethylorthosilicate, ethanol and water; withdrawing the substrate from the L solution to provide the substrate with a coating of the L solution; and heat treating the substrate to form an oxide layer having a refractive index of about 1.45 and to form the optical coating.

According to a still further embodiment of the invention, a method of making an article comprising bent glass that is resistant to cracking and crazing is provided. The method comprises coating a glass substrate with an inner layer comprising an oxide of titanium and an oxide of silicon; coating the inner layer with a middle layer comprising a mixture of an oxide of cerium and at least one oxide of a metal selected from the group consisting of silicon, nickel and transition metals of Group IIIB, Group IVB, Group VB and Group VIB of the Periodic Table; coating the middle layer with an outer layer comprising an oxide of silicon to form a coated glass substrate; bending the coated glass substrate; and making an article comprising the coated glass substrate.

Finally, a method of improving crack resistance in a heat treated inorganic substrate comprises providing to an inorganic substrate a coating having a refractive index of at least about 1.90 comprising a mixture of an oxide of cerium and at least one oxide of a metal selected from the group consisting of silicon, nickel and transition metals of Group IIIB, Group IVB, Group VB and Group VIB of the Periodic Table, and heat treating the coated substrate.

### BRIEF DESCRIPTION OF THE SEVERAL VIEWS OF THE DRAWINGS

The foregoing summary, as well as the following detailed description of the invention, will be better understood when read in conjunction with the appended drawings. For the purpose of illustrating the invention, there are shown in the drawings embodiment(s) which are presently preferred. It should be understood, however, that the invention is not limited to the precise arrangements, instrumentalities, or the specific information shown. In the drawings:

FIG. 1 is an enlarged, partially broken cross-sectional view of a portion of the three-layer multilayer antireflection coating according to one embodiment of the invention; and

FIG. 2 is a graphical representation of percentage of light reflected versus the wavelength of the reflected light for the three layer anti-reflective coating according to Example 4.

### DETAILED DESCRIPTION OF THE INVENTION

The present invention provides a method for producing thin film optical coatings with reduced visible light reflection, which are resistant to stresses such as cracking or crazing upon heat treatments such as tempering or bending. The present invention more particularly relates to a method for providing to an inorganic substrate a coating which includes cerium oxide and at least one oxide of silicon, nickel, or a transition metal of Group IIIB, Group IVB, Group VB or Group VIB of the Periodic Table. Preferably, the transition metal is titanium, tantalum, hafnium or zirconium and the coating comprises at least about 50 mol % of the cerium oxide. In a preferred embodiment, the coating has a refractive index of at least about 1.90, and more preferably at least about 2.0.

According to the present invention, a method for producing a stress-resistant, heat treated, anti-reflection coated substrate that is resistant to cracking and crazing involves coating an inorganic substrate with an inner layer containing an oxide of titanium and an oxide of silicon, coating the inner layer with a middle layer which includes cerium oxide and at least one oxide of silicon, nickel or a transition metal as described previously; and coating the middle layer with an outer layer containing an oxide of silicon. The coated inorganic substrate may then be subjected to a heat treatment step, such as tempering or bending, during which it is resistant to cracking and crazing so that the coating remains intact. In a preferred embodiment, the inner “M” layer has a refractive index of about 1.60 to about 1.90, the middle “H” layer has an refractive index of at least about 1.90 and more preferably at least about 2.0, and the outer “L” layer has a refractive index of about 1.45. The multi-layer stress-resistant coating this has an M/H/L or “three-layer low” design.” Preferably, the middle layer comprises at least about 50 mol % cerium oxide and is sol-gel derived.

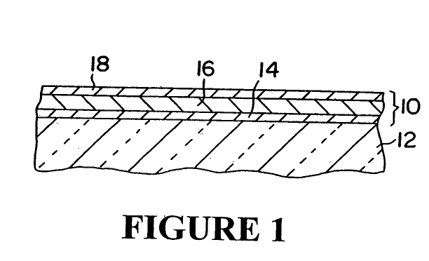

A preferred embodiment of the invention is shown in FIG. 1, which depicts a three-layer multilayer coating containing an inner layer 14, a middle layer 16 and an outer layer 18. As previously explained, the inner layer 14 is an “M” layer, the middle layer 16 is an “H” layer, and the outer layer 18 is an “L” layer. The multilayer antireflection coating, generally designated as 10, is applied to a substrate 12, which is preferably inorganic.

The inorganic substrate for use in the present invention is preferably a glass substrate such as soda lime float glass, borosilicate glass or quartz. However, any substrate known in the art would be applicable for use in the present invention.

In a preferred embodiment, the stress-resistant coating is sol-gel derived. Precursor compounds used for the transition metal oxides within the invention are preferably, but not limited to compounds such as nitrates, chlorides or alkoxides. The addition of chelating and stabilizing agents such as, for example, diketones, glycols and glycol monoethers is preferred for production of films of good optical quality. Specifically, chelating and stabilizing agents such as 1,2-butanediol, 1,2-propanediol, 1,3-propanediol, ethylene glycol, dipropylene glycol monoethyl ether, diethylene glycol monoethyl ether, and triethylene glycol monoethyl ether are most preferred. Typically, concentrations of chelating or stabilizing agents used range from about 1 to about 15 volume %, with the preferred range being from about 3 to about 9 volume % of total stabilizing agents.

Immersion of the substrate can be accomplished in a variety of ways. The particular manner in which the substrate is immersed is in no way critical to the present invention. Immersion can be accomplished by automated or manual means. It should also be understood that with respect to the present invention, immersion can mean both “full” immersion of the substrate into the mixture, as well as the partial immersion of the substrate into the mixture. The substrate is then withdrawn from the mixture, whereby the substrate is provided with a coating of the mixture. The duration of immersion is not critical and may vary. The coating remains on both sides of the surface of the substrate. The film begins to thin due to evaporation of the alcohol. Alternatively, spin-coating methods may be used. As the evaporation occurs, there is a buffer zone of alcohol vapor above the surface of the coating film closer to the dipping solution. As the substrate moves away from the dipping solution, the vapor buffer decreases exposing the coating solution to atmospheric moisture and increasing the rate of reaction.

Acid can further catalyze the reaction. As the concentration of acid increases due to the evaporation of alcohol, the pH will begin to decrease. The chemical reactions are complex and their mechanisms are not fully understood. However, it is believed that the overall reaction rate is catalyzed by the changing (i.e., increasing) concentrations of reactive components, the evaporation of alcohol and the increase in water concentration as described above. The reactions occur in the zone extending longitudinally along the substrate surface as the alcohol is at least partially evaporated.

The substrate is preferably withdrawn from the mixture at a rate of from about 2 mm/s to about 20 mm/s. More preferably, the substrate is withdrawn from the mixture at a rate of from about 6 mm/s to about 12 mm/s. Withdrawal rate is known to affect coating thickness, as explained by H. Schroeder, “Oxide Layers Deposited from Organic Solutions”, Physics of Thin Films, Vol. 5, pp. 87-141, (1969), (hereinafter referred to as “Schroeder”), the entire contents of which are incorporated herein by reference. While the rate at which the substrate is withdrawn is not absolutely critical, the ranges discussed above are generally preferred. It should be understood, however, that any rate could be used in accordance with the present invention in order to vary the resulting thickness, as desired. Also, as discussed in Schroeder, the angle at which the substrate is withdrawn has an effect on the coating thickness and uniformity. According to the present invention, it is preferable that the substrate is withdrawn from the solution such that the longitudinal axis of the substrate is approximately at a 90° angle with the surface of the mixture. While this withdrawal angle is preferable in order to provide even coatings to both sides of the substrate, it should be understood that the present invention may be practiced using any withdrawal angle.

Once the substrate has been withdrawn from the mixture, it may be subjected to intermediate heat-treatments, additional coating processes, and or final cure heat-treatments. The terms “heat-treatment” and “heat-treating” are understood to include either intermediate heating steps or final cure heating steps, or both, unless specified.

Intermediate heat-treating includes heating a substrate at a temperature from about 75° C. to about 200° C. for a period up to about one hour, more preferably from about 5 to about 10 minutes, in order to remove excess fluid. Fluids that may be contained within the coating present on the substrate can include, for example, water, alcohol(s), and acid(s). Final cure heat-treating includes heating a substrate at a temperature of up to about 450° C. Final cure heat-treating times (“soak times”) can range from zero to about twenty-four hours, with the preferred soak time being from about 0.5 to about 2.0 hours. Following heat treatment, the stress-resistant coating has a refractive index of greater than about 1.9 in a preferred embodiment, and more preferably greater than about 2.0.

In numerous applications such as in the production of glass display cases or curved windows, for example, it is necessary to subject the coated glass to subsequent, additional heat treatments such as tempering and/or bending. During bending in particular, stresses are applied to the glass, which may result in damage to the coatings in the form of cracking and/or crazing. The coatings prepared according to the present invention, however, may be subjected to heat treatments such as tempering and/or bending and withstand cracking and crazing. The coated glass substrate may thus be used to form an article comprising bent glass, such as a display case, according to a further embodiment of the invention.

According to a method of the present invention, a stress-resistant, sol-gel derived oxide H layer having a refractive index of greater than about 1.90 can be prepared by immersing a coated substrate into a solution comprising, for example, cerium nitrate hexahydrate, tetraethylorthosilicate and at least one compound of a transition metal of Group IIIB, Group IVB, Group VB or Group VIB of the Periodic Table, withdrawing the substrate from the mixture to provide the substrate with a coating of the solution, and heat treating the substrate to form an oxide layer having a refractive index of at least about 1.90 and preferably at least about 2.0. Preferred transition metals are titanium, tantalum, hafnium and zirconium and the solution preferably contains at least about 50 mol % cerium nitrate hexahydrate.

A sol-gel derived thin film optical coating containing an M layer may be prepared by immersing a substrate into an M solution comprising, for example, tetraethylorthosilicate and the reaction product of titanium chloride and ethanol, withdrawing the substrate from the M solution to provide the substrate with a coating of the M solution, and drying the substrate to form a silicon dioxide and titanium dioxide layer having a refractive index of about 1.60 to about 1.90. During the subsequent preparation of the H layer solution, chelating or stabilizing agents may also be added, such as those previously described. The preparation of the H layer solution may thus involve, for example, aging a precursor solution comprising tetraethylorthosilicate, cerium nitrate hexahydrate, ethanol and a chelating agent.

Further, a multi-layer, stress resistant sol-gel derived, anti-reflective thin film optical coating containing an L layer may be produced by immersing an oxide-coated substrate containing an H layer (and optionally an M layer) into an L solution comprising, for example, tetraethylorthosilicate, ethanol and water, withdrawing the substrate from the L solution to provide the substrate with a coating of the L solution, and heat-treating the substrate to form an oxide layer having a refractive index of about 1.45.

A multi-layer, stress-resistant, anti-reflective, thin film optical coating having an M/H/L structure may be produced according to the present invention by coating a substrate with (1) an M solution followed by heat-treatment, (2) an H solution followed by heat treatment, and (3) an L solution followed by heat treatment. The M/H/L coated substrate may then be subjected to further heat treatment such as tempering or bending, and the coating will not exhibit cracking or crazing.

Additionally, a method of making an article containing bent glass involves forming a multi-layer, stress-resistant, anti-reflective, absorbing thin film optical coating having an M/H/L structure on a substrate using the materials and steps as described previously, bending the coated glass substrate and making an article comprising the coated glass substrate. Preferred glass substrates include soda lime float glass, borosilicate glass and quartz, but any glass contemplated by one skilled in the art would be appropriate. The preferred refractive indices of the inner, middle and outer coating layers on the glass substrate have been previously described. According to the present invention, the article is resistant to cracking and crazing, and would be applicable for use in display cases, for example.

Finally, a method of improving crack resistance in a heat treated inorganic substrate comprises providing to the substrate a coating containing a mixture of cerium oxide and at least one oxide of silicon, nickel or a transition metal from Group IIIB, Group IVB, Group VB or Group VIB of the Periodic Table, and heat treating the coated substrate such as by tempering or bending, for example. In a preferred embodiment, the transition metal is titanium, tantalum, hafnium or zirconium. The coating preferably has a refractive index of greater than about 1.90, and more preferably, greater than about 2.0. It is further preferred if the coating is sol-gel derived and contains at least about 50 mol % cerium.

The invention will now be described based on the following non-limiting examples:

### EXAMPLE 1

A 60 mole percent CeO₂ H-layer solution was formed from cerium (III) nitrate hexahydrate and n-butyl zirconate (80% in n-butanol) as follows:

(1) 350 g of cerium (III) nitrate hexahydrate were dissolved in 700 ml of ethanol. The solution was diluted to a final volume of 1000 ml with ethanol.

(2) The following ingredients were mixed in the order shown:

| | |
|---|---|
| ethanol | 609 ml |
| n-butyl zirconate (80%) | 59 ml |
| glacial acetic acid | 29 ml |
| Solution (1) | 244 ml |
| nitric acid (65%) | 10 ml |
| dipropylene glycol monoethyl ether | 50 ml |

This solution formed a coating having a refractive index of 2.04.

### EXAMPLE 2

An L-layer solution was formed by mixing 119 ml ethanol, 67 ml tetraethylorthosilicate, 40 ml deionized water, and 1 ml HCl (37%) with stirring at room temperature. During stirring at room temperature, the viscosity was measured every hour. When the viscosity reached a value of 3.0-3.2 centistokes the solution was diluted to a final volume of 1000 ml with ethanol. This solution formed a coating having a refractive index of 1.45.

### EXAMPLE 3

An M layer solution was formed as follows:

(1) 277 ml tetraethylorthosilicate, 600 ml ethanol, 55 ml deionized water, and 4 ml HCl (37%) were mixed. The solution was diluted to a final volume of 1000 ml.

(2) 180 ml of titanium chloride were reacted by slow addition (under argon) of 380 ml of ethanol with constant stirring. After the addition was complete, the solution was diluted to a final volume of 1000 ml with ethanol.

(3) 86 ml of Solution (1) of this Example were mixed with 79 ml of Solution (2) of this Example and then diluted with ethanol to a final volume of 1000 ml.

This solution formed a coating having a refractive index of 1.80.

### EXAMPLE 4

A three-layer M/H/L anti-reflective coating was applied to both sides of a 6 mm thick piece of soda-lime float glass, using the M solution described in Example 3, the H solution described in Example 1, and the L solution described in Example 2. A cleaned piece of glass was first dipped in the M solution and withdrawn vertically at a rate of 6.4 mm/sec. The glass was subsequently dried in an oven for 8 minutes at 170° C. After the glass cooled to room temperature, it was dipped into the H solution and withdrawn vertically from that solution at a rate of 7.5 mm/sec. The glass was again dried in an oven for 8 minutes at 170° C., followed by cooling to room temperature.

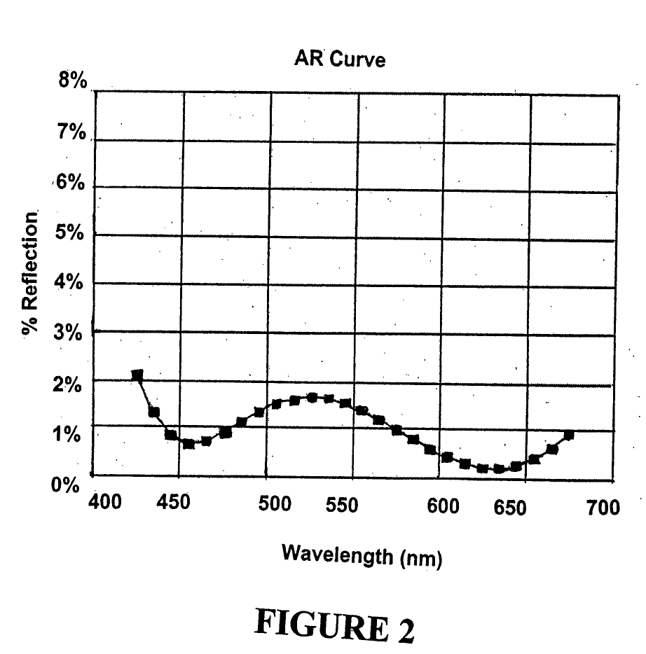

The glass was then heated in a furnace to a temperature of 430° C. in 2 hours, held at 430° C. for 1 hour, and finally cooled slowly (over 3 hours) to room temperature. After cooling, the glass was dipped in the L solution and withdrawn vertically at a rate of 8.0 mm/sec. The glass was again heated in a furnace to 430° C., following the same heating and cooling profile as before. Reflectivity of the coated glass sample was measured, at normal incidence, over the range 425 to 675 nm, and the average reflection was found to be 0.98%. This is shown graphically in FIG. 2.

The coated glass sample was subsequently bent to an angle of 45° with a 3″ radius of curvature. The coating showed no cracking or crazing along the bend.

### EXAMPLE 5

A series of solutions were prepared as described in Example 1 with the mole percentage of CeO₂ ranging from 10 to 90%, with the balance ZrO₂. In all cases, the total concentration of CeO₂—ZrO₂ was maintained at 35 g/l. Each of these solutions was used to form an H layer in a 3-layer M/H/L antireflection system and the resulting coated substrates were subsequently bent to an angle of 45° with a 3″ radius of curvature to investigate the effect of CeO₂ concentration on the cracking and/or crazing of the coating. It was found that at CeO₂ concentrations below 50 mole percent, cracking and crazing occurred when the glass samples were bent. When the concentration of CeO₂ was greater than about 50 mole percent, crazing was minimal.

As can be seen from the above data, the particular systems and techniques of the present invention provide low cost, sol-gel derived antireflective, glass products having good cosmetic appearance and mechanically stable surfaces which may be subjected to heat treatment and withstand cracking and crazing. In one embodiment, the invention provides a coated glass which may be applicable for forming display cases.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention.

We claim:

1. A method for producing a stress-resistant heat-treated anti-reflection coated inorganic substrate comprising:
(a) coating an inorganic substrate with an inner layer comprising an oxide of titanium and an oxide of silicon;
(b) coating the inner layer with a middle layer comprising a mixture of an oxide of cerium and at least one oxide of a metal selected from the group consisting of silicon, nickel and transition metals of Group IIIB, Group IVB, Group VB and Group VIB of the Periodic Table;
(c) coating the middle layer with an outer layer comprising an oxide of silicon; and
(d) heat treating the coated inorganic substrate; wherein the heat-treated anti-reflection coated inorganic substrate is resistant to cracking and crazing.

2. The method according to claim 1, wherein the inner layer has a refractive index of about 1.60 to about 1.90.

3. The method according to claim 1, wherein the middle layer has a refractive index of at least about 1.90.

4. The method according to claim 3, wherein the middle layer has a refractive index of at least about 2.0.

5. The method according to claim 1, wherein the outer layer has a refractive index of about 1.45.

6. The method according to claim 1, wherein the middle layer comprises at least about 50 mol % of the oxide of cerium.

7. The method according to claim 1, wherein at least one of the inner layer, the middle layer and the outer layer is sol-gel derived.

8. The method according to claim 1, wherein the heat treating in step (d) comprises tempering or bending.

9. The method according to claim 1, wherein the middle layer comprises a mixture of an oxide of cerium and at least one oxide of a metal selected from the group consisting of nickel, titanium, tantalum, hafnium, silicon and zirconium.

10. A method for producing a stress-resistant heat-treated anti-reflection coated inorganic substrate comprising:
(a) providing to an inorganic substrate a coating having a refractive index of at least about 1.90 comprising a mixture of an oxide of cerium and at least one oxide of a metal selected from the group consisting of silicon, nickel and transition metals of Group IIIB, Group IVB, Group VB and Group VIB of the Periodic Table, and
(b) heat treating the coated inorganic substrate; wherein the heat-treated anti-reflection coated inorganic substrate is resistant to cracking and crazing.

11. The method according to claim 10, wherein the coating has a refractive index of at least about 2.0.

12. The method according to claim 10, wherein the coating comprises at least about 50 mol % of the oxide of cerium.

13. The method according to claim 10, wherein the coating is sol-gel derived.

14. The method according to claim 10, wherein the heat treating in step (b) comprises tempering or bending.

15. The method according to claim 10, wherein the coating comprises a mixture of an oxide of cerium and at least one oxide of a metal selected from the group consisting of nickel, titanium, tantalum, hafnium, silicon and zirconium.

16. A method for producing a stress-resistant heat-treated sol-gel derived thin film anti-reflection optical coating on an inorganic substrate comprising:
(a) immersing an inorganic substrate in an M solution comprising tetraethylorthosilicate and the reaction product of TiCl₄ and ethanol;
(b) withdrawing the substrate from the M solution to provide the substrate with a coating of the M solution;
(c) heat treating the substrate to form a silicon dioxide and TiO₂ layer having a refractive index of about 1.60 to about 1.90;
(d) immersing the substrate in an H solution comprising cerium nitrate hexahydrate, tetraethylorthosilicate and at least one compound of at least one transition metal of Group IIIB, Group IVB, Group VB or Group VIB of the Periodic Table;
(e) withdrawing the substrate from the H solution to provide the substrate with a coating of the H solution;
(f) heat treating the substrate to form an oxide layer having a refractive index of at least about 1.9;
(g) immersing the substrate in an L solution comprising tetraethylorthosilicate, ethanol and water;
(h) withdrawing the substrate from the L solution to provide the substrate with a coating of the L solution; and
(i) heat treating the substrate to form an oxide layer having a refractive index of about 1.45 and to form the optical coating; wherein the heat-treated sol-gel derived thin film anti-reflection optical coating is resistant to cracking or crazing.

17. The method according to claim 16, wherein the oxide layer in step (f) has a refractive index of at least about 2.0.

18. The method according to claim 16, wherein the at least one transition metal in step (d) is selected from the group consisting of titanium, tantalum, hafnium, and zirconium.

19. The method according to claim 16, wherein the mixture in step (d) comprises at least about 50 mol % cerium nitrate heaxahydrate.

20. A method of making an article comprising bent glass comprising:
(a) coating a glass substrate with an inner layer comprising an oxide of titanium and an oxide of silicon;
(b) coating the inner layer with a middle layer comprising a mixture of an oxide of cerium and at least one oxide of a metal selected from the group consisting of silicon, nickel and transition metals of Group IIIB, Group IVB, Group VB and Group VIB of the Periodic Table;
(c) coating the middle layer with an outer layer comprising an oxide of silicon to form a coated glass substrate;
(d) bending the coated glass substrate; and
(e) making an article comprising the coated glass substrate; wherein the article comprising bent glass is resistant to cracking or crazing.

21. The method according to claim 20, wherein the glass substrate is selected from the group consisting of soda lime float glass, borosilicate glass and quartz.

22. The method according to claim 20, wherein the inner layer has a refractive index of about 1.60 to about 1.90.

23. The method according to claim 20, wherein the middle layer has a refractive index of at least about 1.90.

24. The method according to claim 20, wherein the middle layer has a refractive index of at least about 2.0.

25. The method according to claim 20, wherein the outer layer has a refractive index of about 1.45.

26. The method according to claim 20, wherein the middle layer comprises at least about 50 mol % of the oxide of cerium.

27. The method according to claim 20, wherein the middle layer comprises a mixture of an oxide of cerium and at least one oxide of a metal selected from the group consisting of nickel, titanium, tantalum, hafnium, silicon, and zirconium.

28. The method according to claim 20, wherein the article comprises a display case.

29. The method according to claim 20, wherein at least one of the inner layer, the middle layer and the outer layer is sol-gel derived.

30. The method according to claim 20, wherein step (a) comprises:
(i) immersing the substrate in an M solution comprising tetraethylorthosilicate and the reaction product of TiCl₄ and ethanol;
(ii) withdrawing the substrate from the M solution to provide the substrate with a coating of the M solution; and
(iii) heat treating the substrate to form a silicon dioxide and TiO₂ layer having a refractive index of about 1.60 to about 1.90.

31. The method according to claim 20, wherein step (b) comprises:
(i) immersing the substrate in an H solution comprising cerium nitrate hexahydrate, tetraethylorthosilicate and at least one compound of at least one transition metal of Group IIIB, Group IVB, Group VB or Group VIB of the Periodic Table;
(ii) withdrawing the substrate from the H solution to provide the substrate with a coating of the H solution; and
(iii) heat treating the substrate to form an oxide layer having a refractive index of at least about 1.9;

32. The method according to claim 20, wherein step (c) comprises:
(i) immersing the substrate in an L solution comprising tetraethylorthosilicate, ethanol and water;
(ii) withdrawing the substrate from the L solution to provide the substrate with a coating of the L solution; and
(iii) heat treating the substrate to form an oxide layer having a refractive index of about 1.45.

33. A method of improving crack resistance in a heat treated inorganic substrate comprising:
(a) providing to an inorganic substrate a coating having a refractive index of at least about 1.90 comprising a mixture of an oxide of cerium and at least one oxide of a metal selected from the group consisting of silicon, nickel and transition metals of Group IIIB, Group IVB, Group VB and Group VIB of the Periodic Table; and
(b) heat treating the coated substrate.

34. The method according to claim 33, wherein the coating has a refractive index of at least about 2.0.

35. The method according to claim 33, wherein the coating comprises at least about 50 mol % of the oxide of cerium.

36. The method according to claim 33, wherein the coating is sol-gel derived.

37. The method according to claim 33, wherein the heat treating comprises tempering or bending.

38. The method according to claim 33, wherein the coating comprises a mixture of an oxide of cerium and at least one oxide of a metal selected from the group consisting of nickel, titanium, tantalum, hafnium, silicon and zirconium.
